(19) United States
(12) Patent Application Publication
(10) Pub. No.: US 2018/0304789 A1
(43) Pub. Date: Oct. 25, 2018

(54) ARMREST MODULE FOR AUTOMOBILE SEAT

(71) Applicant: Faurecia Sièges d'Automobile, Nanterre (FR)

(72) Inventor: Jacques ROBERT, Marcoussis (FR)

(21) Appl. No.: 15/958,785

(22) Filed: Apr. 20, 2018

(30) Foreign Application Priority Data
Apr. 20, 2017 (FR) 17 53449

(51) Int. Cl. B60N 2/75; B60N 2/02

(52) U.S. Cl. CPC B60N 2/767; B60N 2/77; B60N 2/0232; B60N 2/777; B60N 2/773

(57) ABSTRACT

An armrest module for an automobile seat intended for attachment to the automobile seat. The armrest module includes an armrest arm intended for supporting the arm of the occupant of the automobile seat, and a device for adjusting the height and attitude of the armrest arm.

### TECHNICAL FIELD

The present invention relates to an armrest module for an automobile seat and an automobile seat provided with such an armrest module.

### BACKGROUND

In the automotive field, it is known that an automobile seat comprises a seat and a backrest, the backrest being pivotally mounted relative to the seat around a transverse direction axis relative to the seat.

It is known that this type of automobile seat is provided with an armrest allowing a seat occupant to rest his arm on the armrest.

Such an armrest generally has a low degree of adjustment in position. Most often, the armrest is simply mounted on the backrest, pivotable around a transverse direction axis relative to the seat.

This simple rotation does not guarantee the comfort of the vehicle seat's occupant.

### SUMMARY

An objective of this invention is therefore to provide an armrest module for an automobile seat that will improve the comfort of its occupant.

This objective may be achieved by means of an armrest module for an automobile seat, intended to be fixed on an automobile seat, which comprises:
an armrest arm intended to support the arm of an occupant of the automobile seat, and
a device for adjusting the height and the pitch attitude of the armrest arm.

Thus, the armrest module according to at least some embodiments of the invention favorably allows a greater variety of adjustments compared to at least many of the armrests of the prior art, and makes it possible to better adapt to the occupant of the automobile seat and thereby provide him with increased comfort.

It should be noted that in typical armrests of the prior art, only the pitch attitude of the armrest arm can actually be adjusted, thus the occupant must make a compromise between the height of the armrest and its inclination.

According to preferred embodiments, the armrest module in various embodiments of the invention has one or more of the following characteristics, taken alone or in combination:
the armrest module comprises a connecting rod, preferably exactly a connecting rod, intended to be rotatably mounted against a seating frame of an automobile seat, in the vicinity of a first end, around an axis that is substantially parallel to a transverse direction of the automobile seat, with the armrest arm being rotatably mounted against the connecting rod, in the vicinity of a second end of the connecting rod, around an axis substantially parallel to the transverse direction of the automobile seat;
the armrest module comprises at least a first slide, intended to be fixed to a seating frame of an automobile seat, preferably substantially vertically, with the armrest arm pivotally mounted against the first slide around an axis that is substantially parallel to a transverse direction of the automobile seat;
the armrest module comprises:
a first slide, preferably exactly a first slide, with the armrest arm being freely pivotable against the first slide, and
at least one second slide, the armrest arm being connected to at least one second slide so as to allow pivoting of the armrest arm against the first slide;
one extremity of at least one second slide is received in abutment at the end of a substantially cylindrical housing formed in the armrest arm, with the housing having an oblong cross section;
the armrest module comprises a peg intended to be received in a guide rail fixed to a backrest frame of an automobile seat, the armrest arm being rotatably mounted against the peg around an axis substantially parallel to a transverse direction of the automobile seat and/or the peg being adapted to be received in the guide rail, so as to further be able to pivot around an axis substantially parallel to the transverse direction of the automobile seat;
the armrest module further comprises an armrest arm of adjustable length;
the armrest arm has a first and a second member, the second member being transposable with the first member, preferably in a substantially longitudinal direction of the armrest arm;
the armrest module comprises a human-machine interface at one end of the armrest arm, specifically at one end of the second member, where appropriate, preferably at a front end of the armrest arm or the second member, where appropriate;
the armrest module comprises an electrical control for the armrest module settings, with the electrical control preferably formed by the human-machine interface, where appropriate;
the armrest module comprises a mechanical adjustment control of the armrest module; and
the armrest module comprises a mechanical adjustment device for the armrest module and a device for blocking or releasing the mechanical adjustment device, with said blocking or releasing device being mechanically and/or electrically controlled.

The invention also relates to an automobile seat comprising a seat with a seating frame and/or a backrest with a backrest frame, and an armrest module as described above in all of its combinations, attached to the seating frame or the backrest frame.

The backrest frame can be pivotally mounted against the seating frame, around a substantially transverse axis of the automobile seat.

The seating frame may comprise legs and slides such that the position of the legs in the slides can be changed by transposing them and/or the height of the legs is adjustable.

There is also provided an armrest module for an automobile seat, intended to be fixed on an automobile seat, comprising:
an armrest to support the arm of an occupant of the automobile seat, and
at least one slide, attached to the armrest arm and intended to be fixed to an automobile seat.

This armrest module may comprise one or more of the following features taken alone or in combination:
at least one slide is intended to be attached to a seating frame;
at least one slide is intended to extend, once attached to the automobile seat, specifically to the seating frame of the automobile seat, in a direction forming an angle less than 45° with a vertical direction, preferably an angle of less than 30° with a vertical direction;
at least one slide is intended to extend, once attached to the automobile seat, specifically to the seating frame of the automobile seat, in a substantially vertical direction;
the armrest module comprises exactly one slide or two slides;
the armrest arm comprises a human-machine interface, preferably at a front end of the armrest arm;
the armrest arm is of adjustable length, comprising for example a first and a second member, the second member being movable by transposing with the first member;
the human-machine interface is fixed on the second member of the armrest arm, preferably in the vicinity of a front end of the second member;
the armrest arm is rigidly attached to one end of the slide, substantially preventing any rotation of the armrest arm against the slide;
the armrest module comprises an electric or mechanical control of the length of at least one slide and/or the length of the armrest arm, and, where appropriate, with the electric control preferably being formed by the human-machine interface;
the armrest module comprises a blocking device of the armrest module position, and once set, the blocking device is electrically or mechanically controlled;
the blocking device comprises a stud resiliently constrained in a complementary housing formed on a movable slide element to adjust the length of said slide.

There is further provided an automobile seat comprising a seat with a seating frame and/or a backrest with a backrest frame, and an armrest module as described above in all of its combinations, attached to the backrest frame or, preferably, to the seating frame.

In such an automobile seat, the backrest frame can be pivotally mounted against the seating frame, around a substantially transverse axis of the automobile seat.

The seating frame may comprise legs and slides such that the position of the legs in the slides can be changed by transposing them and/or the height of the legs is adjustable.

### BRIEF DESCRIPTION OF THE DRAWINGS

Other aspects, objectives and advantages of the invention will appear upon reading the following description, which refers to the attached drawings among which:

FIGS. 1 and 2 schematically show a side view of a first example of an automobile seat fitted with an armrest module in two different positions, given by way of examples only;

FIGS. 3 and 4 schematically show a side view of a second example of an automobile seat fitted with an armrest module in two different positions, given by way of examples only;

FIGS. 5 and 6 schematically show a side view of a third example of an automobile seat fitted with an armrest module in two different positions, given by way of examples only;

FIG. 7 schematically shows detail VII of FIG. 5;

FIGS. 8 and 9 schematically show a side view of a fourth example of an automobile seat fitted with an armrest module in two different positions, given by way of examples only;

FIGS. 10a, 10b schematically illustrate a first example of a blocking device of an armrest module that can be implemented in the armrest module of FIGS. 8 and 9, in the blocking position and released position respectively; and

FIGS. 11a, 11b schematically illustrate a second example of a blocking device of an armrest module that can be implemented in the armrest module of FIGS. 8 and 9, in the blocking position and released position respectively.

### DETAILED DESCRIPTION

In the remainder of the description, elements that are identical or of identical function bear the same reference sign. For brevity of the present description, these elements are not described in the context of each example, but only the differences between these various examples are described in detail.

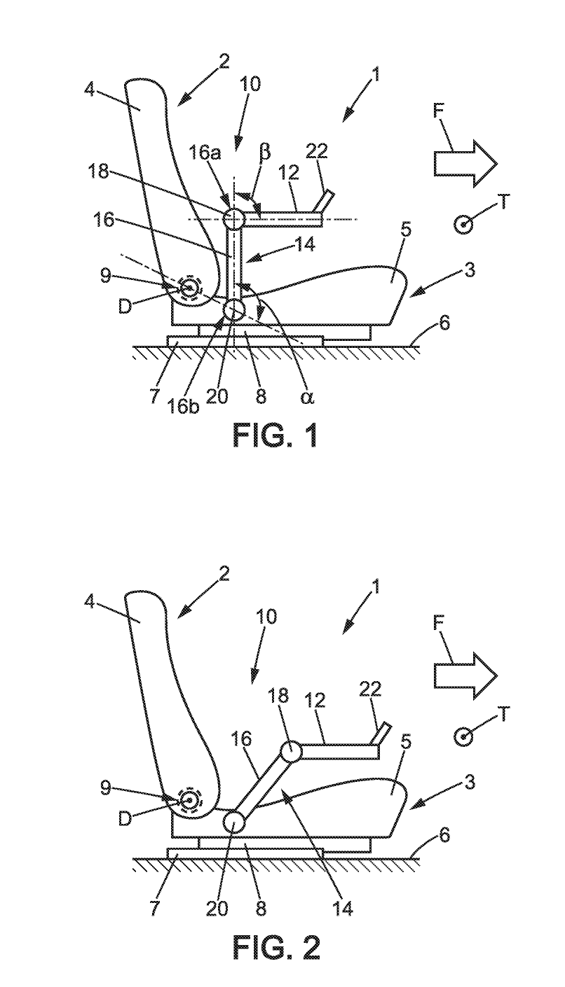

FIG. 1 illustrates a seat 1 of an automobile. The seat 1 comprises a backrest 2 and a seating part 3. The backrest 2 comprises a backrest frame 4. The seating part 3 comprises a seating frame 5. The backrest frame 4 is substantially mounted in a pivot connection around a D axis, on the seating frame 5. The seating frame 5 itself can be mounted on the floor 6 of the automobile, for example by means of slides 7 of the seat 1. In this case, the seating frame 5 has legs 8 which are received in the slides 7, so that the position of the legs 8 in the slides 7 can be modified by translation in the direction F of the automobile's normal forward movement. The height of the legs 8 can also be adjustable. Thus, one can adjust the position of the seat 1 with respect to the steering wheel (not shown) of the automobile, in a longitudinal direction of the automobile seat corresponding to the direction F of the automobile's forward movement in normal operation.

A hinge device 9 here makes it possible to adjust the inclination of the backrest frame 4 in relation to the seating frame 5 and to block the inclination of the backrest frame 4. Such a hinge device 9 is well known to those skilled in the art. Therefore, for the sake of brevity of the present description, this hinge device 9 is not described in more detail here.

In addition, in FIGS. 1 and 2, the seat 1 is fitted with a first example of an armrest module 10.

Such an armrest module 10 essentially comprises, according to the examples of

FIGS. 1 and 2, an armrest arm 12 intended to support the arm of the occupant of seat 1 and a device 14 to adjust the height and the attitude of the armrest arm 12. It will be recalled that the attitude—or pitch attitude—of the armrest arm 12 is, by definition, the inclination of a longitudinal axis of the armrest arm 12 relative to the horizontal. Thus, in other words, the armrest module 10 comprises means for modifying the vertical position of the armrest arm and its inclination, in the FIG. 1 plane, either forward or backward according to the normal F direction of the vehicle's forward movement. In this way, unlike an armrest of the prior art, here it is possible to have the armrest arm 12 at different heights and, at each height, to orient it in different degrees of inclination.

In these FIGS. 1 and 2, the device 14 for adjusting the height and the attitude of the armrest arm 12 essentially comprises a connecting rod 16 rotatably mounted to the seating frame 5 of the automobile seat 1 around an axis substantially parallel to a transverse direction T of the seat 1 of an automobile, the connecting rod 16 also being rotatably mounted to the armrest arm 12, around an axis substantially parallel to the transverse direction T. This transverse direction T is, for example, that of a line normal to the median plane or symmetry plane of the seat, the plane containing the direction F of the normal automobile's forward movement.

Here, a connecting rod is understood to be any rigid mechanical part adapted to connect two other mechanical parts so that the other two mechanical parts are movable relative to each other. Particularly, a connecting rod may have, or consist of, a portion extending to a main direction of extension, between two ends. A connecting rod preferably has fixed dimensions.

In the example of FIGS. 1 and 2, the connecting rod 16 is fixed adjacent to a first end 16a, vertically the highest, to the armrest arm 12. At this first end 16a, the connecting rod 16 is rotatably mounted on the armrest arm 12, around an axis substantially parallel to the transverse direction T. For example, a first pivot 18, with an axis parallel to the transverse direction T, is formed between the connecting rod 16 and the armrest arm 12 at this first end 16a of the connecting rod 16, to allow the relative rotation of the connecting rod 16 relative to the armrest arm 12.

At its second end 16b, opposite to the first end 16a and therefore located here vertically the lowest, the connecting rod 16 is fixed on the seating frame 5. Here, at this second end 16b, the connecting rod 16 is rotatable relative to the seating frame 5, around an axis substantially parallel to the transverse direction T. For example, a second pivot 20, of axis parallel to the transverse direction T, is formed between the connecting rod 16 and the seating frame 5, at this second end 16b of the connecting rod 16, to allow the relative rotation of the connecting rod 16 relative to the seating frame 5.

With such an armrest module 10, the attitude and the height of the armrest arm 12 can particularly be adjusted independently. Because it is rotatably mounted relative to the seating frame 5, the connecting rod 16 makes it possible to modify the height of the armrest arm 12, while allowing to adjust the attitude of the armrest arm 12 because it is rotatably fixed to the armrest arm. The armrest module 10 thus allows a greater variety of adjustments to the position of the armrest arm 12 than the prior art, thereby allowing improvement in the comfort of the occupant.

Furthermore, it should be noted that because the armrest module 10 is fixed to the seating frame 5, the attitude of the armrest arm 12 is not influenced by the orientation of the backrest frame 4, when the latter is modified by the seat occupant.

According to the examples of FIGS. 1 and 2, the armrest module 10 also comprises a human-machine interface 22. This human-machine interface 22 is for example in the vicinity of the front end of the armrest arm 12, in the direction F of the normal automobile's forward movement.

This human-machine interface 22 may comprise command settings for:
adjusting the position of the seat 1, particularly the position of the legs 8 in the slides 7, the height of the legs 8, the relative inclination of the backrest frame 4 relative to the seating frame 5 around the D axis;
adjusting the position of the armrest module 10, particularly when the latter's setting is adjusted using a controllable actuator;
adjusting any other parameter in the automobile, such as, for example, the car radio tuning, the GPS, the position of the exterior mirrors, the interior rearview mirror, the steering wheel's position relative to the dashboard;
controls such as the central locking of doors, the activation of hazard lights;
or any other command accessible to those skilled in the art.

Thus, the adjustment in the improved position of the armrest module 10 allows the occupant of the seat 1 to access these commands and/or adjustments more easily, thereby improving the seat occupant's comfort even more while using the vehicle.

The armrest module 10 has two degrees of position adjustment according to the example illustrated in FIGS. 1 and 2, namely:
the angle α of relative rotation of the connecting rod 16 relative to the seating frame 5; and
the angle β of relative rotation of the connecting rod 16 relative to the armrest arm 12.

According to a first example of implementation, these two degrees of adjustment can be modified by means of an electrical control, particularly by means of the human-machine interface 22. This is possible for instance, when the armrest module 10 comprises electrically controlled actuators adapted to change the two degrees of adjustment α and β. The actuators may especially be motors, particularly electric motors, cylinders, particularly electric or pneumatic cylinders, or any other actuator accessible to those skilled in the art.

In this case, holding the connecting rod 16 in relative position against the seating frame 5 and against the armrest arm 12 can be accomplished in various ways accessible to those skilled in the art. In particular, this holding in position can be mechanical, by friction or by limit stops in the actuators involved in setting the degrees of adjustment, thus ensuring this holding in position. Alternatively, this holding in position can be achieved using electric actuators. In particular, an electromagnet can selectively be implemented to allow or, on the contrary, prevent one or more, including all degrees of adjustment from being modified, simultaneously or not.

According to a variant, the armrest module 10 comprises mechanical actuators adapted to modify the degrees of adjustment. The mechanical actuators are, for example, levers, gear wheels or push buttons. In this case, the holding in position of the connecting rod 16 and the armrest arm 12 can be achieved mechanically, in the absence of an action by the occupant to change the degrees of adjustment. In particular, friction or limit stops may be involved in this case. According to another variant, at least one mechanical blocking device in the position of one or more degrees of adjustment can be provided. For instance, this can be operated by means of a lever or a push button. Alternatively, at least one electrical blocking device in the position of one or more degrees of adjustment can be provided. If necessary, this can be controlled by means of the human-machine interface. The modification of the degrees of adjustment can also be carried out manually, by acting directly on the connecting rod 16 and/or the armrest arm 12, once the degrees of adjustment are released by the blocking device of these degrees of adjustment.

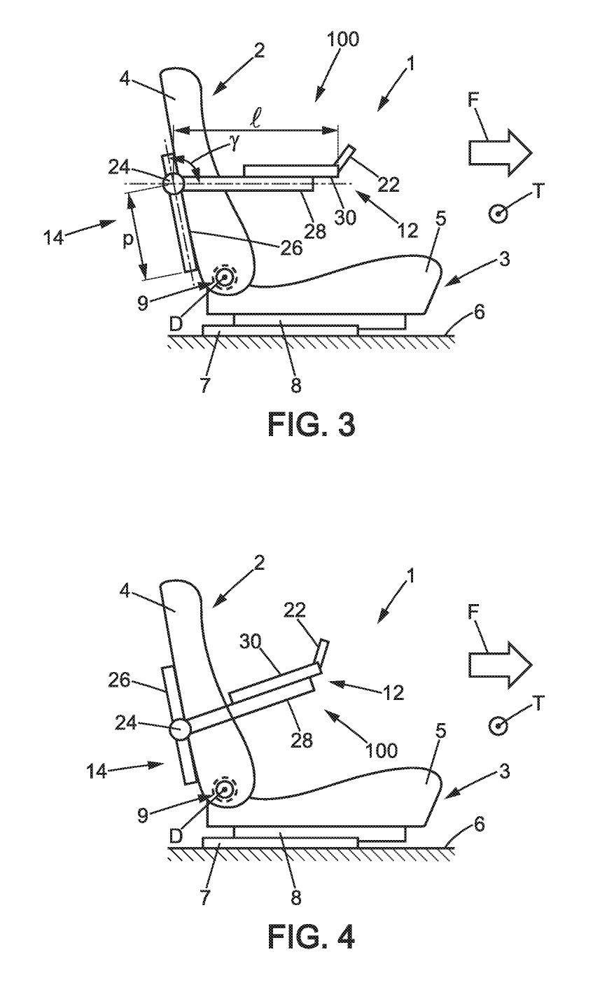

The example of an automobile seat in FIGS. 3 and 4 is essentially distinguished from the example of FIGS. 1 and 2 by the shape taken by the device 14 for adjusting the height and the attitude of the armrest arm 12 of the armrest module 100. Here, in fact, it essentially comprises a peg 24 received in a guide rail 26, here as a translation guide, fixed on the backrest frame 4, the armrest arm 12 being rotatably mounted to the peg 24 around an axis substantially parallel to the transverse direction T.

Here, a peg is understood to be any mechanical part that can be fitted in the guide rail 26 and can be displaced by translation in the direction of the extension of the guide rail 26 and if necessary, in rotation along an axis perpendicular to the direction of translation.

Thus, translation of the peg 24 in the guide rail 26 essentially allows to adjust the armrest arm's height, while the rotation of the armrest arm allows to adjust the attitude of the latter.

Alternatively, or in addition, the peg 24 is formed by the armrest arm 12 and is received in the guide rail 26 so as to allow translation of the peg 24 in the guide rail 26, on the one hand, as well as rotation around an axis parallel to the transverse direction T of the automobile seat 1, on the other hand. In this case, the peg 24 can be rigidly attached to the armrest arm 12, and in particular, the peg 24 can be formed by the armrest arm 12.

Furthermore, according to the example of FIGS. 3 and 4, to further increase the variety of possible settings of the armrest module 100, it has an armrest arm 12 of adjustable length l. To do this, the armrest arm 12 has a first member 28 and a second member 30, such that the second member 30 is adapted to be translated relative to the first member 28, preferably in a longitudinal direction of the armrest arm 12, more preferably, to the direction F of the normal automobile's forward movement. For example, the first piece 28 may form a guide rail receiving a portion of the second member 30 so that, preferably, the second member 30 can only translate relative to the first member 28. The first and second members 28, 30 thus form a slide. Alternatively, the first and second members 28, 30 may be telescopic.

In the case of FIGS. 3 and 4, in which the armrest arm 12 is of adjustable length l, it is advantageous for the human-machine interface 22 to be in the vicinity of the front end of the second member 22 of the armrest arm 12, in the direction F of normal forward movement. This facilitates access for the occupant of the seat 1, after having adjusted the length l of the armrest arm.

Still in this case, the length l of the armrest arm forms a third degree of adjustment, with the relative position p of the peg 24 in the rail 26 and the angle γ between the guide rail 26 and the armrest arm 12. Once the desired adjustments are made by the occupant of the vehicle seat 1, the modification of these degrees of adjustment l, γ and p and their position maintenance can be made as described above in the context of the first example of automobile seat described with reference to FIGS. 1 and 2.

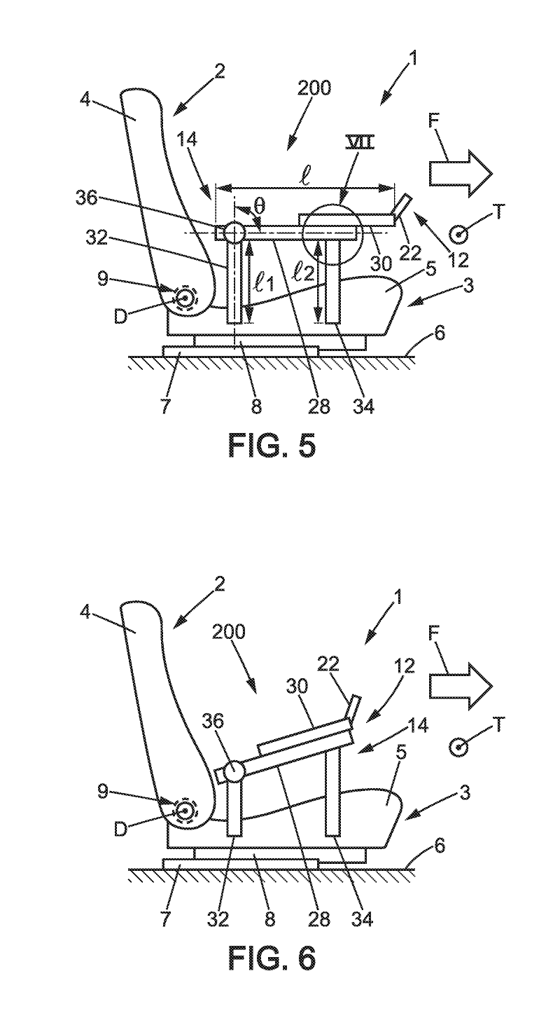

FIGS. 5 and 6 illustrate a third example of an automobile seat fitted with a third example 200 of armrest module.

This third armrest module 200 is also distinguished from the first two examples 10, 100 by the shape taken by the device 14 for adjusting the height and the attitude of the armrest arm 12.

Here, in fact, this device 14 for adjusting the height and the attitude of the armrest arm 12 essentially comprises a first slide 32 and a second slide 34, the first slide 32 being located closer to the rear of the seat 1 than the second slide 34, according to the direction F of the normal automobile's forward movement. The first and second slides 32, 34 are fixed at one end to the seating frame 5. Thus, the first and second slides 32, 34 cannot move or specifically pivot around a transverse axis, relative to the seating frame 5. The first and second slides 32, 34 are preferably parallel. The first and second slides 32, 34 may substantially extend vertically as illustrated in FIGS. 5 and 6. However, according to a variant that is not illustrated, the first and second slides 32, 34 do not extend in a vertical direction but, on the contrary, form a non-zero angle with respect to a vertical direction. However, in order to adjust the height of the armrest arm 12, it is preferred that the first and second rails 32, 34 form an angle less than 90° to the vertical. More preferably still, so that the adjustment of the height of the armrest arm 12 is not accompanied by an excessive displacement in the normal direction F of the automobile's forward movement, the angle formed by the first and second slides 32, 34 with the vertical is less than 45°, or better, less than 30°.

Furthermore, the armrest arm 12 is pivotally mounted relative to the first slide 32, around an axis substantially parallel to the transverse direction T. This can particularly be achieved by forming a free pivot 36 between the armrest arm 12 and the first slide 32, particularly between the armrest arm 12 and the end of the first slide 32, opposite the end of the first slide 32 fixed to the seating frame 5.

It should be noted here that the pivot connection between the first slide 32 and the armrest arm 12 is free. It is not necessary to have a device to specifically, that is to say directly adjust this rotation of the armrest arm 12 relative to the first slide 32. Indeed, this rotation is in fact indirectly controlled by the elongation of the first 32 and second 34 slides.

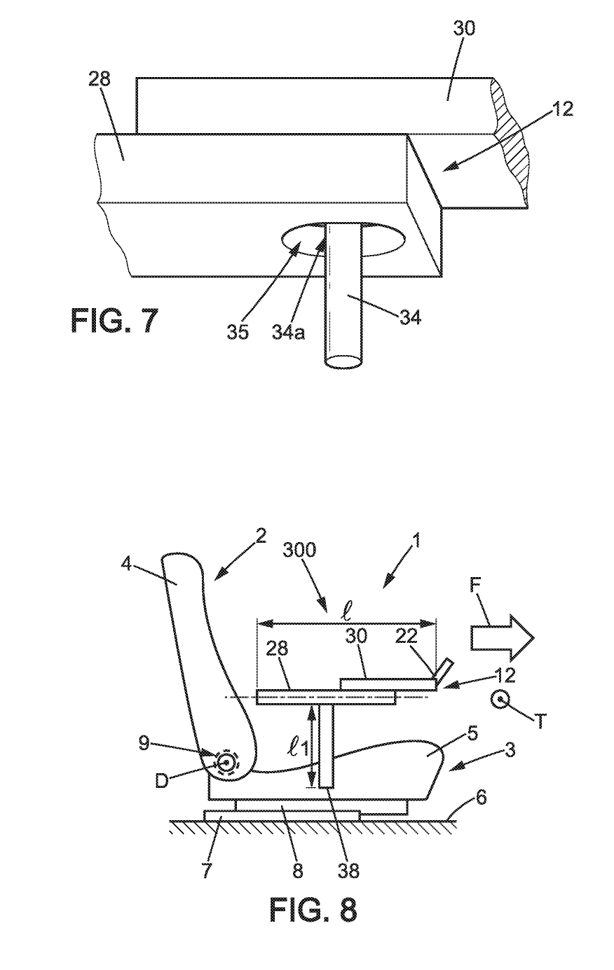

Furthermore, the armrest arm 12 is also connected to the second slide 34 so as to allow pivoting of the armrest arm 12 on the first slide 34, while maintaining a contact between the armrest arm and the end of the second slide 34 opposite the end of the second slide 34 attached to the seating frame 5. To do this, one can, for instance, form an annular linear connection between the armrest arm 12 and the second slide 34. In practice, the armrest arm 12 can be received in contact on the second slide 34 end which is not attached to the seating frame 5. Alternatively, this end 34a of the second slide 34 which is not fixed to the seating frame 5 can be received in a housing 35 of a substantially cylindrical shape and formed in the armrest arm 12, the housing 35 being of oblong cross-section as illustrated in FIG. 7. Thus, the end 34a of the second slide 34 abuts the bottom of the housing 35, and the oblong shape of this housing 35 section allows the rotation of the armrest arm 12, while ensuring a better mechanical strength of the assembly, compared to the case of a single support of the armrest arm 12 on the end of the second slide 34, due to the weight of the armrest arm.

In this third example, the degrees of adjustment may include:
the length l1 of the first slide;
the length l2 of the second slide; and
the length l of the armrest arm.

As explained above, it is not necessary to directly adjust the angle θ between the armrest arm 12 and the first slide 32. This angle θ is in fact defined by the lengths l1, l2 of the two slides 32, 34. Alternatively, one can adjust the length l1, l2 of a single slide and the angle θ between the armrest arm 12 and the first slide 32. The other slide, whose length is not directly adjustable, can then be resiliently constrained towards the armrest arm 32 which forms a limit stop for the extension of this other slide.

In all cases, the degrees of adjustment l, l1 and l2; l, l1 and θ; or l, l2 and θ can be set and then maintained as explained above in the context of the first example.

According to a variant not shown, the armrest arm 12 is rotatably fixed on a single slide 32.

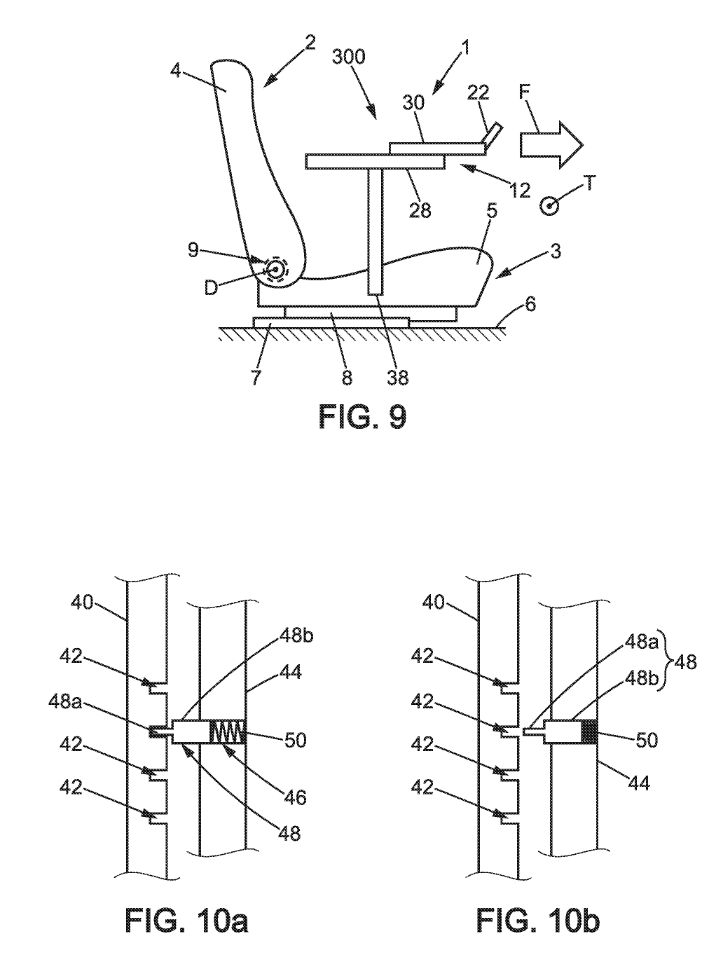

The fourth example of FIGS. 8 and 9 comprises an armrest module 300 essentially having an armrest arm 12 fastened to a slide 38, itself attached to the seating frame 5. The slide 38 is thus immobile with respect to the seating frame 5.

Such an armrest module 300 particularly allows the height adjustment of the armrest arm 12. Here, the slide 38 is single but more than one slide 38 can be implemented, for instance, exactly two slides 38. The slide 38 extends in the illustrated example in a substantially vertical direction. Alternatively, however, the slide 38 does not extend in a vertical direction. Preferably, however, the slide 38 forms an angle of less than 90° with the vertical direction. In particular, to limit the displacement of the armrest arm 12 when adjusting its height, the angle between the longitudinal direction of the slide 38 and a vertical direction is less than 45°, better still, less than 30°.

The length l1 of the slide 38 in this example makes it possible to adjust the height of the armrest arm 12.

Furthermore, in the example shown, the armrest arm 12 is of adjustable length. Alternatively, however, the armrest arm 12 may be of given and fixed length.

Also, in the example of FIGS. 8 and 9, the slide 38 is fixed on the seating frame 5. In a variant, however, the slide 38 may be fixed on the backrest frame 4.

In the example of FIGS. 8 and 9, the adjustment of the length l1 of the slide 38 can be achieved as explained in the preceding examples above in the context of setting the different degrees of adjustment.

However, FIGS. 10a and 10b, on one hand, and 11a and 11b, on the other hand, illustrate variants of devices for holding (or blocking) the slide 38 in position, which can also be implemented in the examples previously described.

In FIG. 10a, a movable member 40 of the slide 38 is shown, provided on one of its faces with several substantially identical notches 42. The notches for example are of cylindrical shape, for example with a circular cross section. Here, these notches 42 are spaced at substantially constant intervals. Furthermore, FIG. 10a illustrates a frame 44 which may, for example, be formed by a casing of the slide 38, in particular a casing in which the movable element 40 of the slide 38 slides. This frame 44 is for example mounted fixed on the seating frame 5 of the automobile seat. This frame 44 forms a housing 46 for receiving a stud 48 of substantially cylindrical shape. The stud 48 here has a substantially cylindrical shape per section. A first section 48a has a diameter substantially equal to the diameter of the notches 42 such that the first section 48a is adapted to be received in the notches 42. The second section 48b is of complementary section to the section of the housing 46 in the frame 44, such that the second section 48b is adapted to be received in this housing 46. The first section 48a is also adapted to be received in the housing 46. However, the second section 48b is not adapted to be received in the slots 42. For example, the diameter of the second section 48b is greater than the diameter of the first section 48a and the diameter of the notches 42. The stud 48 is resiliently constrained, here by a spring 50, so that the first portion 48a of the stud 48 is received in one of the notches 42. This position corresponds to a blocking of the length l1 of the slide 38.

On the contrary, in FIG. 10b, the blocking device is in the unblocked (or unlocked) position allowing the length l1 of the slide 38 to be adjusted. In this unlocked position, the stud 48 is entirely outside the notches 42 so that the movable member 40 of the slide 38 can be moved relative to the frame 44. To move the stud 48, a force is exerted against the stress of the spring 50. This force exerted is greater than the effort of stress of the spring 50. This force can particularly be magnetic, mechanical or pneumatic on the stud 48 and/or the spring 50.

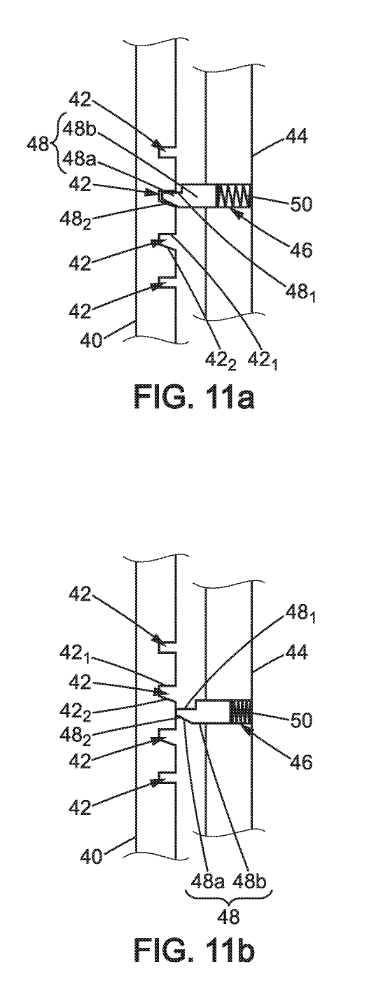

The FIGS. 11a and 11b example of the blocking device is substantially similar to the example of FIGS. 10a and 10b. This second example of blocking device essentially differs from the first previously described example by the shape of the notches 42 and the first portion 48a of the stud 48. In this second example, the notches 42 and the first portion 48a of the stud 48 instead have complementary sections in the form of rectangular trapezoids. Thus, in section, the notches 42 and the first portion 48a of the stud 48 have:
a first face 42₁, 48₁ substantially perpendicular to the direction of extension of the slide 38 corresponding to the direction of translation of the movable member 40 relative to the frame 44. As illustrated in the figures, this first face is preferably the upper face; and
a second face 42₂, 48₂ inclined in relation to this direction of extension of the slide 38 which corresponds to the direction of translation of the movable member 40 with respect to the frame. As illustrated in the figures, this second face is preferably the lower face.

Thus, when a user places his arm on the armrest arm 12 attached to the end of the slide 38, the upper face 48₁ of the stud 48 forms a limit stop for the upper face 42₁ of the notch 42 which receives it, as explained above in the context of the example in FIGS. 10 and 10b. Thus, the movable member 40 of the slide 38 is immobilized in the downward translation, preventing the armrest arm 12 from going down.

Now, if the user wants to raise the armrest arm 12, all he has to do is pull on the armrest arm 12 upwards. In this case then, the inclined face 42₂ of the notch 42 receiving the stud 48 will work with the inclined face 48₂ of the stud 48 to guide the stud 48 out of the notch 42, as a result of the movement of the movable member 40 of the slide 38. The user can thus pull the armrest arm to the next notch 42. This is because when the stud 48 is in front of this next notch 42, the spring 50 then constrains the stud 48 into this next notch 42. The height adjustment of the armrest arm 12 is thus achieved by snapping.

To lower the armrest arm 12, on the other hand, a device for releasing the movable element 40 is necessary, as in the case of the FIGS. 10a and 10b example. As explained above, this release device acts on the stud 48 against the stress of the spring 50 to pull out the stud 48 from a notch 42 in which it was lodged and, preferably, to keep the stud 48 in this position out of the notches 42, for as long as the release device is actuated. As explained above, this release device may in particular be of magnetic, mechanical or pneumatic action on the stud 48 and/or the spring 50.

The present invention is not limited only to the embodiments just described but is adaptable to numerous variants accessible to those skilled in the art.

In particular, the various embodiments can be combined as long as they are not contradictory.

Also, the fact that the armrest arm is of adjustable length or, conversely, of given and fixed length, can be provided in each of the examples presented.

1. An armrest module for an automobile seat, for attachment to the automobile seat, comprising:
an armrest arm for supporting the arm of an occupant of the automobile seat, and
a device for adjusting the height and attitude of the armrest arm.

2. The armrest module according to claim 1, comprising a connecting rod, intended to be rotatably mounted relative to a seating frame of an automobile seat, in the vicinity of a first end, around an axis substantially parallel to a transverse direction of the automobile seat, the armrest arm being rotatably mounted relative to the connecting rod, in the vicinity of a second end of the connecting rod, around an axis substantially parallel to the transverse direction of the automobile seat.

3. The armrest module according to claim 1, comprising at least a first slide, intended to be fixed on a seating frame of an automobile seat, the armrest arm being pivotally mounted relative to the first slide, around an axis substantially parallel to a transverse direction of the automobile seat.

4. The armrest module according to claim 3, comprising
a first slide, the armrest arm being freely pivotable relative to the first slide, and
at least one second slide, the armrest arm being connected to the at least one second slide so as to allow the armrest arm to pivot relative to the first slide.

5. The armrest module according to claim 4, wherein one end of the at least one second slide is abutted in the far end of a substantially cylindrical housing formed in the armrest arm, the housing having an oblong cross section.

6. The armrest module according to claim 1, comprising a peg intended to be received in a guide rail fixed to a backrest frame of an automobile seat, the armrest arm being rotatably mounted relative to the peg around an axis substantially parallel to a transverse direction of the automobile seat and/or the peg being intended to be received in the guide rail so as to be able to further pivot around an axis substantially parallel to the transverse direction of the automobile seat.

7. The armrest module according to claim 1, further comprising an armrest arm of adjustable length.

8. The armrest module according to claim 7, wherein the armrest arm has a first and a second member, the second member being translatable in relation to the first member.

9. The armrest module according to claim 8, wherein the second member is translatable in relation to the first member in a substantially longitudinal direction of the armrest arm.

10. The armrest module according to claim 1 comprising a human-machine interface at one end of the armrest arm, in particular at one end of the second member, where appropriate, preferably at a front end of the armrest arm or the second member, as the case may be.

11. The armrest module according to claim 1, comprising an electrical control of the armrest module adjustment, the electrical control preferably being formed by the human-machine interface, if applicable.

12. The armrest module according to claim 1, comprising a mechanical adjustment control of the armrest module.

13. The armrest module according to claim 1, comprising a mechanical device for adjusting the armrest module and a device for blocking or releasing the mechanical adjustment device, said mechanical adjustment device being mechanically and/or electrically controlled.

14. An automobile seat comprising a seat with a seating frame and/or a backrest with a backrest frame, and an armrest module according to claim 1, attached to the seating frame or the backrest frame.
